(19) United States
(12) Patent Application Publication
(10) Pub. No.: US 2013/0060793 A1
(43) Pub. Date: Mar. 7, 2013

(54) EXTRACTING INFORMATION FROM MEDICAL DOCUMENTS

(71) Applicants: Subhadip Bandyopadhyay, Kolkata (IN); Arijit Laha, Burdwan (IN); Devika Mathur, Bareilly (IN); Pratibha Rani, Patna (IN); Raghunath Reddy, Mahbubnagar (IN)

(72) Inventors: Subhadip Bandyopadhyay, Kolkata (IN); Arijit Laha, Burdwan (IN); Devika Mathur, Bareilly (IN); Pratibha Rani, Patna (IN); Raghunath Reddy, Mahbubnagar (IN)

(73) Assignee: Infosys Limited, Bangalore (IN)

(21) Appl. No.: 13/224,223

(22) Filed: Sep. 1, 2011

(51) Int. Cl. G06F 17/30

(52) U.S. Cl. 707/755; 707/E17.009

(57) ABSTRACT

Information extraction techniques are provided for extracting information from medical documents. Information can be extracted from medical documents by determining a plurality of classes of medical information and, for each class of the plurality of classes of medical information, selecting one or more extraction techniques according to the class, and using the selected extraction techniques to extract information from the medical documents. Different extraction techniques can be applied depending on the specific class of medical information. Specific classes of medical information can be determined based on a type of information consumer, such as a physician or pharmacist.

### BACKGROUND

Clinical informatics (CI) is a recent field of information technology (IT) application research emphasizing better quality of patient care in combination with cost optimization and better management of patient care data. The core technology behind clinical informatics lies in the domain of electronic health care data management and information extraction.

Medical information regarding patient care is generated in a variety of ways. For example, medical information can be generated during different patient care activities, such as patient examinations, tests and results, treatments, forms and surveys, etc. These different types of information can be collected into various medical documents, such as notes, charts, reports, etc.

Due to the different activities involved with patient care and information collection, segregating or identifying specific information within medical documents can be difficult. For example, the vocabulary, semantics and sentence format corresponding to activities such as symptoms collection and medical test result composition are markedly different. The first type is a mixture of deep semantics related to feelings and observations on clinical events often forming different types of regular expressions, whereas the second type is more prominent with typical medical vocabulary.

Therefore, there exists ample opportunity for improvement in technologies related to extracting information from medical documents.

### SUMMARY

A variety of technologies related to extracting information from medical documents are applied.

For example, a method for extracting information from medical documents is described. The method comprises determining a plurality of classes of medical information, and for each class of the plurality of classes of medical information: selecting one or more extraction techniques according to the class, and using the one or more selected extraction techniques, extracting information from the medical documents. The medical documents contain information related to a patient's medical care. The plurality of classes of medical information can be determined based on a type of information consumer, such as a physician or pharmacist. Once the information has been extracted, it can be stored. For example, the information can be stored in a knowledge repository or knowledge base (e.g., organized according to the classes of medical information).

As another example a computing device for extracting information from medical documents is described. The computing device can comprise a processing unit and storage media. The storage media store instructions for causing the computing device to perform a method for extracting information from medical documents. The method comprises determining a plurality of classes of medical information, and for each class of the plurality of classes of medical information: selecting one or more extraction techniques according to the class, and using the one or more selected extraction techniques, extracting information from the medical documents.

As another example, a computer-readable medium storing computer-executable instructions for causing a computing device to perform a method for extracting information from medical documents is described. The method comprises determining a type of information consumer, determining a plurality of classes of medical information based on the type of information consumer and relevant to the type of information consumer, and for each class of the plurality of classes of medical information: selecting one or more extraction techniques according to the class, and using the one or more selected extraction techniques, extracting information from the medical documents.

The foregoing and other features and advantages of the invention will become more apparent from the following detailed description, which proceeds with reference to the accompanying figures.

### BRIEF DESCRIPTION OF THE DRAWINGS

FIG. 1 is a flowchart showing an example method for extracting information from medical documents.

FIG. 2 is a flowchart showing an example method for using extraction techniques depending on the selected class of medical information.

FIG. 3 is a flowchart showing an example method for extracting information relevant to a type of information consumer.

FIG. 4 is a flowchart showing an example method for extracting information from medical documents for specific classes of information.

FIG. 5 is a diagram showing an example patient care flow.

FIG. 6 is a flowchart showing an example method for extracting information from medical documents using specific classes of medical information and specific extraction techniques.

FIG. 7 is a block diagram showing an example computing device.

### DETAILED DESCRIPTION OF EXEMPLARY EMBODIMENTS

The following description is directed to techniques and solutions for extracting information from medical documents. The various techniques and solutions can be used in combination or independently. Different embodiments can implement one or more of the described techniques and solutions.

In the techniques and solutions described herein, information is extracted from medical documents. Medical documents refer to information associated with the medical care of a patient. For example, medical documents can include medical files, notes, reports, charts, medical case research reports, and any other type of document that contains information related to patient care. Medical documents can be in electronic format or converted to electronic format. Medical documents can be in an unstructured format or in a structured format.

Medical documents can contain a variety of information. The different types of information in a medical document may be organized (e.g., into different sections) or mixed. In order to facilitate extraction of desired information, different sections of the medical document can be identified (e.g., past and present medical history). In addition, different extraction techniques can be applied to extract different types of information.

The information extracted from medical documents can comprise words, terms, values, phrases, passages, sentences, and/or other pieces of information contained in medical documents. The extracted information can be stored in a database (e.g., a knowledge base). Contextual searching can be used to search for information stored in a database. For example, searching can be performed within a specific class of medical information (e.g., within a diagnosis class or a tests/results class).

I. Identifying the Information Consumer

In the techniques and solutions described herein, information relevant to a specific context can be extracted. The context refers to the type of person who will be utilizing the extracted information. For example, the information consumer could be a physician, pharmacist, administrator, or another type of information consumer.

Different contexts (different types of information consumers) are interested in different types of information. For example, a physician may be interested in classes of medical information such as diagnosis, tests and results, treatment, etc. A pharmacist may be interested in different classes of medical information, such as medications, diseases, etc. A nurse may be interested in classes of medical information such as treatment plans, follow-ups, etc.

II. Determining Classes of Medical Information

Medical documents contain various types of medical information. The different types of information can be segregated within the medical documents, or they can be intermingled. In order to extract useful information from medical documents, information is extracted based on classes (categories or types) of information.

The selection of classes of medical information depends on the relevance of the classes to the information consumer. For example, a physician may be interested in specific classes of medical information, including past medical history, signs and symptoms, diagnoses, treatments, tests and results, and follow-ups. Therefore, if a physician is the type of information consumer who will utilize the extracted information, then classes of information relevant to the physician can be extracted.

If different types of information consumers will be using the extracted information, then information can be extracted for classes relevant to the different types of information consumers. The extracted information can be stored in a database (e.g., categorized by the classes). The stored information can be searched or otherwise utilized by any of the specific types of information consumers (e.g., contextual searching) based on classes relevant to their type (e.g., a physician can search or otherwise utilize information stored within classes relevant to the physician).

III. Methods for Extracting Information from Medical Documents

In the techniques and solutions described herein, methods for extracting information from medical documents are provided.

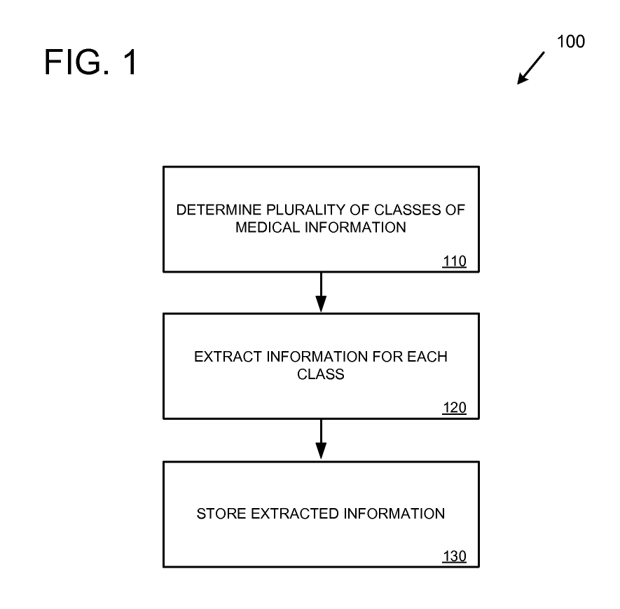

FIG. 1 is a flowchart showing an example method 100 for extracting information from medical documents. At 110, a plurality of classes of medical information are determined. For example, the plurality of classes of medical information can be relevant to a specific context (e.g., relevant to a physician). The plurality of classes of medical information 110 can be determined based on a selected context. For example, if a physician context is selected, then a set of classes of medical information associated with the physician context can be selected.

At 120, information is extracted from medical documents for each class of the plurality of classes of medical information 110. For example, different extraction techniques can be applied for extracting information from different classes. Depending on the class, one or more techniques can be applied to extract information for that class.

At 130, the extracted information is stored. For example, the extracted information can be stored in a database (e.g., a knowledge repository or knowledge base). The stored information can be accessed using search criteria, such as patient criteria (e.g., patient name) and class criteria (e.g., past medical history, tests and results, diagnosis, etc.).

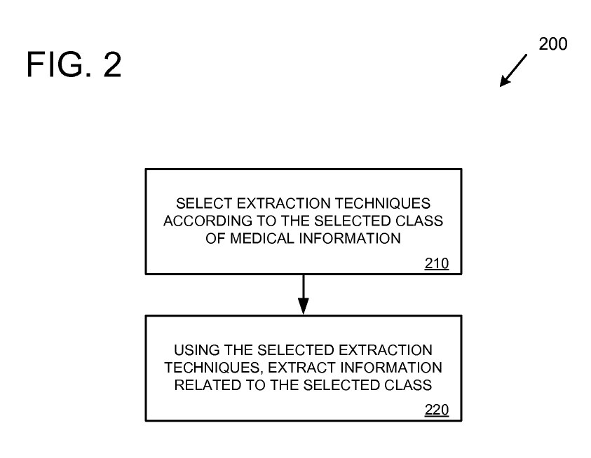

FIG. 2 is a flowchart showing an example method 200 for using extraction techniques depending on the selected class of medical information. At 210, extraction techniques are selected according to the selected class of medical information. Depending on the specific characteristics of the selected class of medical information, different extraction techniques may be needed to effectively extract information related to the class from the medical documents. For example, a dictionary based lookup and matching technique may be used for extracting information for a diagnosis class (e.g., the dictionary may contain common medical diagnosis names and terms for use in lookup and matching operations). On the other hand, a regular expression based pattern matching extraction technique may be used for extracting information for a patient general information class (e.g., for information such as patient name, age, gender, etc.).

In a specific implementation, a set of extraction techniques are available. For example, the set of extraction techniques can comprise a regular expression based pattern matching technique, a dictionary based lookup and matching technique, and a heuristic based passage extraction technique. From the set of extraction techniques, one or more techniques are selected depending on the specific class of medical information. In some situations, a single extraction technique (e.g., dictionary based lookup and matching) may be sufficient for extracting the desired information for the class. In other situations, multiple extraction techniques may be needed (e.g., in combination) to extract the desired information. For example, when extracting information for a test and test results class, a dictionary based technique used to extract test information (e.g., specific test names and/or descriptions) in combination with a regular expression technique used to extract test result information.

At 220, the selected extraction techniques 210 are used to extract information related to the selected class of medical information. The extracted information can be stored in a database for later use.

In a specific implementation, the example method 200 is performed for each of a plurality of classes of medical information. For example, the method 200 can be performed for one or more of the following classes of medical information: patient information, past medical history, signs and symptoms, diagnoses, treatments, tests and results, and follow-ups.

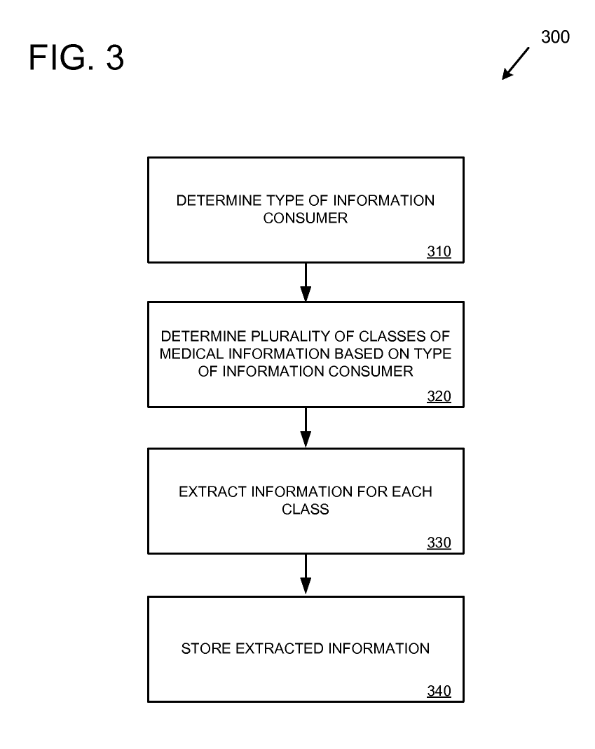

FIG. 3 is a flowchart showing an example method 300 for extracting information relevant to a type of information consumer. At 310, a type of information consumer is determined. For example, the type of information consumer can be a physician, a pharmacist, or another type of information consumer. The type of information consumer is used as the context for determining which classes of medical information are relevant to the information consumer.

At 320, a plurality of classes of medical information are determined based on the type of information consumer 310. For example, if the type of information consumer 310 is a physician, then a plurality of classes of medical information relevant to a physician can be determined (e.g., classes such as past medical history, signs and symptoms, diagnoses, treatments, tests and results, and follow-ups).

At 330, information is extracted from medical documents for each class of the plurality of classes of medical information 320. For example, different extraction techniques can be applied for extracting information for different classes.

At 340, the extracted information is stored. For example, the extract information can be stored in a knowledge repository or knowledge base. The stored information can be accessed using search criteria, such as patient criteria (e.g., patient name) and class criteria (e.g., past medical history, tests and results, diagnosis, etc.).

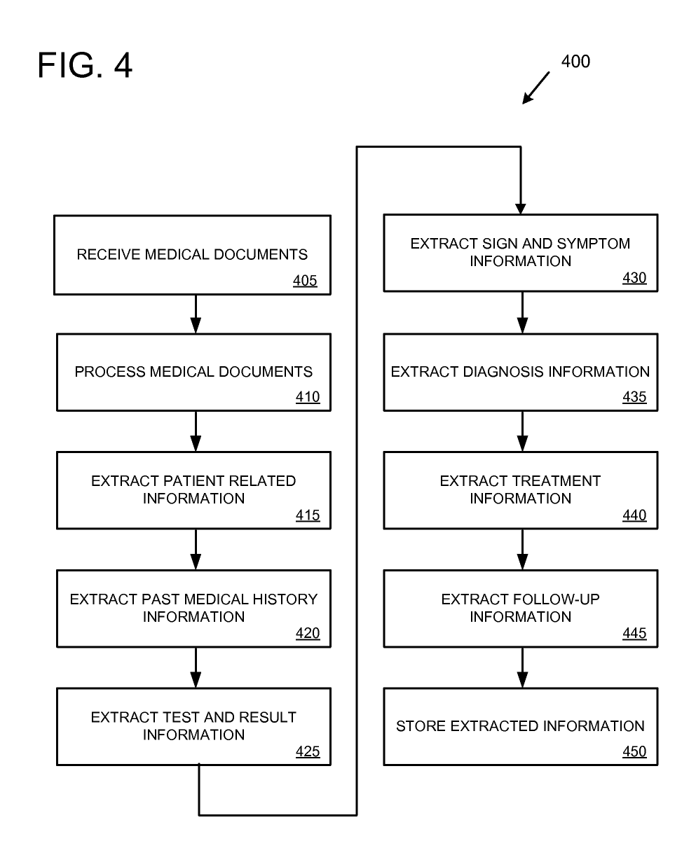

FIG. 4 is a flowchart showing an example method 400 for extracting information from medical documents for specific classes of information. The example method 400 can be used for a specific implementation where the type of information consumer is a physician.

At 405, medical documents are received. For example, the medical documents can comprise unstructured and/or structured documents related to patient care activity.

At 410, the medical documents are processed. For example, the processing 410 can comprise removing elements from the medical documents that will not be used by the extraction techniques, such as links, pictures, etc. In a specific implementation, the processed medical documents are plain text files.

At 415, patient related information is extracted from the processed medical documents 410. Patient related information can comprise information such as the patient's age, gender, name, address, etc. In a specific implementation, a regular expression based pattern matching technique is used to extract the patient related information.

At 420, past medical history information is extracted from the processed medical documents 410. In a specific implementation, temporal logic (a heuristic based approach) is used to segregate the information in the medical documents into past medical information and present medical information. The temporal logic heuristic based approach uses sets of past and present words/phrases to identify sections (e.g., sentences) of the medical documents related to past medical history.

At 425, test and result information is extracted from the processed medical documents 410. In a specific implementation, dictionary based lookup in combination with regular expression based pattern matching is used to extract test and result information. For example, regular expressions can be used to identify test result information that contains numerical information (e.g., 70 mg/dl). Dictionary lookup can be used to identify test names and/or descriptions.

At 430, sign and symptom information is extracted from the processed medical documents 410. In a specific implementation, dictionary based lookup is used to extract the sign and symptom information.

At 435, diagnosis information is extracted from the processed medical documents 410. In a specific implementation, dictionary based lookup is used to extract the diagnosis information.

At 440, treatment information is extracted from the processed medical documents 410. In a specific implementation, dictionary based lookup is used to extract the treatment information.

At 445, follow-up information is extracted from the processed medical documents 410. In a specific implementation, a combination of dictionary based lookup and heuristics are used to extract the follow-up information.

At 450, the extracted information is stored. For example, the extracted information can be stored in a knowledge base or database.

In a specific implementation, certain classes of medical information can be extracted only from present medical information (excluding past medical history). For example, a technique (e.g., as described at 420) can be used to separate past and current medical content from medical documents. From the current medical information, specific classes of medical information can be extracted, such as test and result information, sign and symptom information, diagnosis information, and/or treatment information. Extracting specific classes of medical information from only current medical content allows one to focus on the current medical status of a patient.

Iv. Patient Care Flow

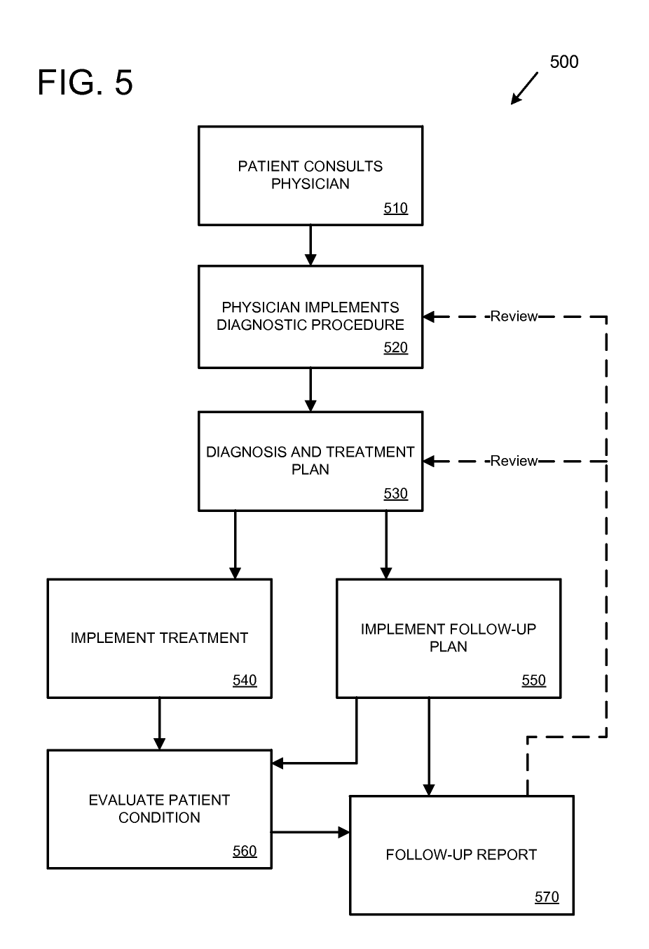

FIG. 5 is a diagram showing an example an example patient care flow 500 as an ordered activity network. The patient care flow 500 depicts various activities and sub-activities involved with providing medical care for a patient.

The patient care process begins when the patient consults the physician 510 (or other health care professional). At 520, diagnostic procedures are performed, which results in a diagnosis and treatment plan 530.

From the diagnosis and treatment plan 530, activity can proceed to implementing treatment 540 or implementing a follow-up plan 550. After treatment 540 or a follow-up plan 550, the patient's condition can be evaluated 560. The follow-up plan 550 can be revised during ongoing treatment. Follow-up activities can involve evaluation of the patient's condition.

Activity proceeds with a follow-up report 570. The follow-up report 570 is reviewed during subsequent (e.g., follow-up) diagnostic procedures 520 and/or diagnosis and treatment plans 530, if such additional procedures 520 and/or plans 530 are needed.

As indicated by the example patient care flow 500, different classes of information are collected in relation to different activities and sub-activities. For example, diagnosis information is collected at 530. Due to differences in each of the activities and sub-activities, information collected at each stage in the patient care flow 500 may use different vocabulary, semantics, structure, sentence format, etc., and thus benefit from different types of extraction techniques.

V. Method for Extracting Information from Medical Documents Using Specific Classes and Techniques

In the techniques and solutions described herein, methods for extracting information from medical documents are provided.

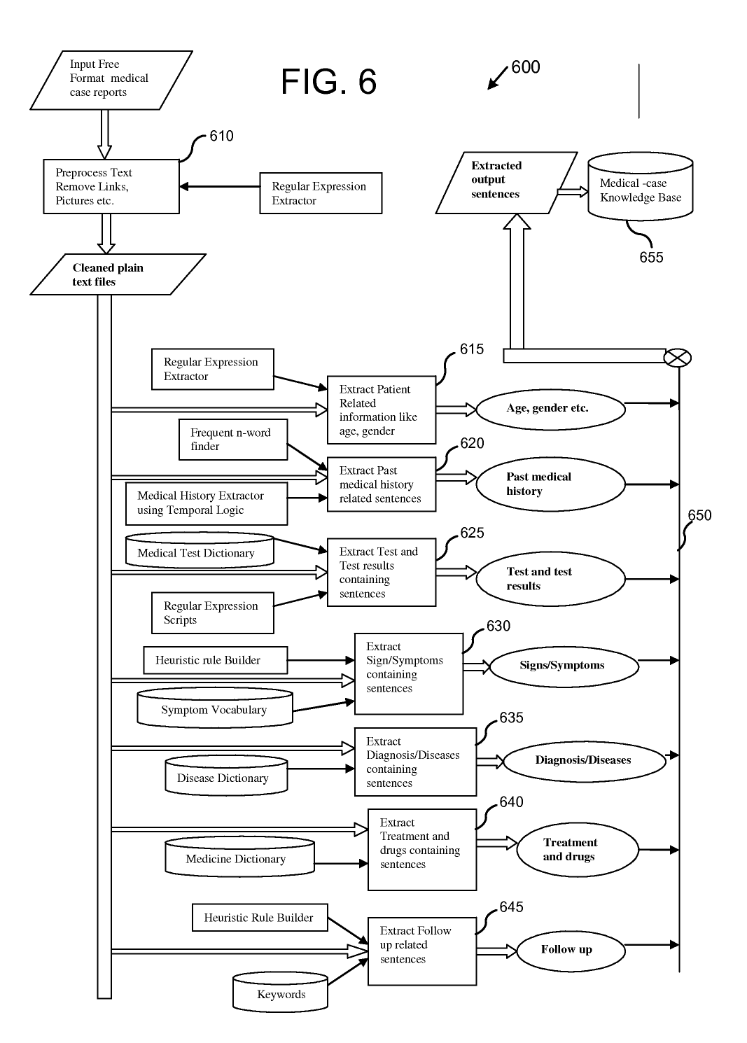

FIG. 6 is a flowchart showing an example method 600 for extracting information from medical documents using specific classes of medical information and specific extraction techniques. At 610, medical documents (e.g., unstructured and/or structured medical documents) are received and processed. For example, the processing can include removing links, pictures, and/or other non-text elements. Cleaned files (e.g., plain text) are produced from the processing, and are provided for use by the various extraction techniques.

After the medical documents are processed 610, a number of extraction techniques (615-645) extract information related to a number of classes of medical information. At 615, patient related information (e.g., age, gender, etc.) is extracted using a regular expression based pattern matching technique.

At 620, past medical history information is extracted. In order to extract past medical history, temporal logic (a heuristic based approach) is used to segregate the information in the medical documents into past medical information and present medical information. The temporal logic heuristic based approach uses sets of past and present words/phrases to identify sections (e.g., sentences) of the medical documents related to past medical history.

At 625, test and test result information is extracted. Extraction of test and result information involves dictionary based lookup in combination with regular expression based pattern matching.

At 630, sign and symptom information is extracted. Extraction of sign and symptom information uses heuristic rules in combination with dictionary based lookup.

At 635, diagnosis and disease information is extracted. Extraction of diagnosis and disease information uses a dictionary based lookup technique.

At 640, treatment and drug information is extracted. Extraction of treatment and drug information uses a dictionary based lookup technique.

At 645, follow-up information is extracted. Extraction of follow-up information uses heuristic rules in combination with dictionary based lookup.

The extracted information for the various classes of medical information is collected 650. For example, the extracted information can comprise words, phrases, sentences, values, and other content. The collected information is stored in a medical knowledge base 655. Once stored in the medical knowledge base 655, the information can be accessed as needed. For example, searches can be performed within a specific class of medical information (e.g., a search performed for a specific medical condition within the past medical information class of extracted information). For example, such contextual searching allows the user to search for specific information (e.g., within only one or a few classes) without having to review the original medical documents.

VI. Extracting Patient Information

In a specific implementation, the following extraction techniques are used to extract patient related information from medical documents. Patient related information refers to information such as the patient's name, age, date of birth, address, etc.

In the specific implementation the following procedure is used to extract patient related information.
1. Manually analyze training set to find patterns for age and gender information contained in the sentences.
2. Make regular expressions GEN and AGE from the patterns.
3. Iterate over the input medical documents
   Find sentences which contain regular expressions GEN and AGE
   Output the matched part of first sentence as Age and Gender.

VII. Extracting Past Medical History Information

In a specific implementation, the following extraction techniques are used to extract past medical history information from medical documents. In some types of medical documents, such as medical case research reports, past and present medical information is not explicitly segregated, although there can be some spatial order to the content (e.g., past medical history can appear before present medical information in the document). In such situations, a heuristic approach can be applied. For example, the heuristic approach can identify past medical history information as a group of content (e.g., sentences) at or near the beginning of a medical document. Analysis of a specific set of medical case research reports showed past medical history usually appeared in the first half of the report. In some situations, past medical history information at or near the beginning of the medical document can be distinguished from present medical history by identifying a “narration of the case” section of the document.

By examining medical documents, such as medical case research reports, a set of words and phrases can be identified as common words and phrases present in past and present medical information. Using a sample set of medical case reports, the following words and phrases have been identified for each category.

history pattern={for several years, was on therapy, ago, past, history, year previously, no previous, years previously, many years, when aged, week before, months earlier, years earlier, previous year, before admission, prior to admission, prior to presentation}

present pattern={while, treated, initial, demonstrated, showed, confirmed, investigations, reveal, complained, initially, given, treatment, exam, diagnostics, presentation, received, arrived, admission, now, normal, diagnosed, was admitted, presented to, on along, presented with, admitted with, admittance, upon arrival, indicative, indicated, discharge, on arrival, yet, so far, shortly, presently, recently, follow up, meanwhile, within, physical examination, on physical examination}

In the specific implementation, the following two procedures (FindWordSeq and Identify Frequent Word Patterns) are used to build the set of history words/phrases (history pattern) and the set of present words/phrases (present pattern) using a training set of documents.

FindWordSeq Procedure
1. Find frequency of each word in the text/*store it in a Hashmap*/
2. Repeat step 3 for window size k=1, 2, 3
3. While (not end of text)
   Use a sliding window of size k
   If (all the words in the window are frequent)/*use Hashmap values*/
   Output the word sequence
   Read new text in window

Identify Frequent Word Patterns Procedure
1. Use temporal logic to make two set of files—one set containing sentences belonging to past medical history and other set containing non past medical history sentences (present). For example, the technique described in Bramsen et al., “Finding Temporal Order in Discharge Summaries,” AMIA Annual Symposium Proc., pages 81-85 (2006) can be used to identify sentences containing past and present medical information.
2. Extract frequent single words from the two set of files. For example, the technique described in Burdick et al., “MAFIA: A Maximal Frequent Itemset Algorithm for Transactional Databases,” Proceedings of the 17th International Conference on Data Engineering, Heidelberg, Germany, 10 pages (April 2001) can be used to extract frequent single words.
3. Use FindWordSeq procedure (depicted above) to find frequent continuous word sequence from the two sets of files.
4. Remove duplicates from both the sets.
5. Remove common phrases present in both the sets.
6. Label the frequent text phrases of past medical history as “history pattern” and the frequent text phrases of non-past medical history as “present pattern.”

Once the “history pattern” and “present pattern” sets have been identified, they can be used in a heuristic based procedure to extract past medical history passages from medical documents. The following procedure, Extract History, is used to extract the past medical history. Using the history pattern and present pattern sets, the below Extract History procedure exploits the chronological sentence order present in the medical document to extract the past medical history information. One single scan of the document provides the information. Time complexity of this procedure is linear and depends on the number of sentences.

Extract History
1. Mark each sentence as history category sentence or present category sentence on the basis of phrases or words in history pattern and present pattern respectively.
   If a sentence contains words in history pattern mark it as history category sentence.
   If a sentence contains present pattern mark it as present category sentence.
   If a sentence contains words both in history pattern and present pattern mark it as history category sentence.
2. The sentence belonging to history category sentence marks the beginning of past medical history. Go on including sentences in past medical history until first present category sentence is encountered. (The sentences marked in step 1 help in identifying the beginning and end of past medical history).
3. Repeat step 2 to find past medical history sentences that are found at different places in the medical document.

VIII. Extracting Test and Result Information

In a specific implementation, the following extraction techniques are used to extract test and test result information from medical documents. In the specific implementation the following procedure is used to extract test and test result related information.
1. Manually analyze training set to find patterns for test result information contained in the sentences.
2. Make regular expression TEST from the patterns.
3. Find keywords associated with test name/methods contained in the training sentences and make a dictionary of test related keywords DictTest. In some situations, additional open source information (e.g., medical dictionaries) on tests and results can be consulted. For example, public domain medical information can be obtained from PubMed (pubmed.gov), operated by the U.S. National Library of Medicine.
4. Add more keywords in dictionary DictTest found from analyzing other sets of documents containing test related information.
5. Remove “past medical history” related sentences from the input medical document and make file NonPMHinput
6. Iterate over NonPMHinput file
   Find sentences which contain regular expressions Test.
   Find sentences which contain words from dictionary DictTest.
   Output the matched sentences.

IX. Extracting Sign and Symptom Information

In a specific implementation, the following extraction techniques are used to extract sign and symptom information from medical documents. In the specific implementation the following procedure is used to extract sign and symptom related information.
1. Find keywords associated with sign/symptoms contained in the training sentences and make a dictionary of keywords DictSign.
2. Add more keywords in dictionary DictSign found from analyzing other sets of documents containing sign/symptom related information.
3. Remove “past medical history” related sentence from the input medical document and make file NonPMHinput
4. Iterate over NonPMHinput file
   Find sentences which contain words from dictionary DictSign.
   Output the matched sentences.

X. Extracting Diagnosis Information

In a specific implementation, the following extraction techniques are used to extract diagnosis information from medical documents. In the specific implementation the following procedure is used to extract diagnosis related information.
1. Find keywords associated with diagnosis/disease contained in the training sentences and make a dictionary of keywords DictDisease.
2. Add more keywords in dictionary DictDisease found from analyzing other sets of documents containing diagnosis/disease related information.
3. Remove “past medical history” related sentence from the input document and make file NonPMHinput.
4. Iterate over NonPMHinput file
   Find sentences which contain words from dictionary DictDisease.
   Output the matched sentences.

XI. Extracting Treatment Information

In a specific implementation, the following extraction techniques are used to extract treatment information from medical documents. Treatment information also includes information related to drugs and medications.

In the specific implementation the following procedure is used to extract treatment related information.
1. Find keywords associated with treatment/drugs contained in the training sentences and make a dictionary of keywords DictDrug.
2. Add more keywords in dictionary DictDrug found from analyzing other sets of documents containing treatment/drug related information.
3. Remove “past medical history” related sentence from the input document and make file NonPMHinput.
4. Iterate over NonPMHinput file
   Find sentences which contain words from dictionary DictDrug.
   Output the matched sentences.

XII. Extracting Follow-Up Information

In a specific implementation, the following extraction techniques are used to extract follow-up information from medical documents. In some situations, follow-up related information can be identified, at least in part, by its location in a medical document. For example, sentences before a conclusion or discussion section have been found to commonly contain follow-up related information based on analysis of sample documents, such as medical case research reports.

In the specific implementation the following procedure is used to extract follow-up related information.
1. Manually analyze training set to find set of keywords FollowSet found in follow up sentences.
2. Iterate over the input document
   If “Conclusion/Discussion” section is present in the document then find last paragraph before that section
      Find sentences from this paragraph which contain words from set FollowSet
   Else find last paragraph of document
      Find sentences from this paragraph which contain words from set FollowSet
   Output the matched sentences.

XIII. Experimental Results

The specific implementation described above in Sections V through XII was applied to a test set of medical case report documents related to heart disease. The specific test set of documents (obtained from Journal of Medical Case Reports) had the following attributes.
1. There are two broad sections containing the main case presentation and discussion but typically the information from different fields are entangled. One notable thing is that the follow up part is often found in the discussion part entangled with other information.
2. The sequence of events describing a patient care process is not followed quite often and later issues are described first.
3. The vocabulary exhibits domain dependence.
4. Numerical values with typical units and characters are present.
5. The whole report is written after the completion of treatment. Hence recognition of the past medical history related sentence/passage can be more problematic than in other types of reports or documents.

A training corpus was used to learn the regular expressions and other notable features to derive heuristic rules. The results of the manually tagged test corpus was compared with the system extracted results to judge the performance. A sentence is considered as the unit level of comparison and Precision and Recall are computed by comparing the system extracted sentences and the corresponding manual extraction. Since the information belonging to the different information classes are not distributed uniformly within and as well as between documents, a more useful way to measure performance is to consider individual classes over the corpus and evaluate the performance separately for them. The macroscopic method of combining the results is used in which equal weight is given to all the samples and Precision and Recall values are averaged over all the test samples.

Table 1 below presents the overall Precision, Recall and F measure values obtained over test corpus for the following classes of medical information: past medical history, sign/symptom, test and test results, disease/diagnosis, treatment, and follow up. Note that the F₁ measure is the harmonic mean of Precision and Recall measures while F₂ gives twice the weight to Recall and F_{0.5} gives twice weight to Precision.

F₂=(1+2²)*Precision*Recall/(Precision+2²*Recall)

F_{0.5}=(1+2²)*Precision*Recall/(2²*Precision+Recall)

TABLE 1

| Class | Precision | Recall | F₁ | F₂ | F_{0.5} |
|---|---|---|---|---|---|
| Diagnosis | 1 | 0.849206 | 0.918455 | 0.875614 | 0.965704 |
| Sign/ | 0.457173 | 0.412698 | 0.433799 | 0.420887 | 0.447528 |
| Symptom | | | | | |
| Past Medical | 0.774376 | 0.588889 | 0.669014 | 0.61852 | 0.728485 |
| History | | | | | |
| Tests and | 0.714361 | 0.379107 | 0.49534 | 0.418376 | 0.607003 |
| Results | | | | | |
| Treatment | 0.5 | 0.39418 | 0.440828 | 0.411602 | 0.474522 |
| Follow up | 0.444709 | 0.620075 | 0.517951 | 0.574746 | 0.471371 |

The results depicted in Table 1 above show excellent performance for diagnosis and good performance for past medical history. For follow up performance is average. But for signs/symptoms and test and treatment, performance is less than average. One reason for the less than average performance for sign/symptom and test and treatment is due to the limited content of the corresponding dictionaries. Use of additional keywords in these dictionaries (e.g., obtained from additional training documents and/or domain expert knowledge) should significantly improve the performance for these classes. In addition, natural language processing techniques can be applied for, but not limited to, the sign/symptom class and the follow up class.

XIV. Example Computing Device

The techniques and solutions described herein can be performed by software and/or hardware of a computing environment, such as a computing device. For example, computing devices include server computers, desktop computers, laptop computers, notebook computers, netbooks, tablet devices, mobile devices, and other types of computing devices. The techniques and solutions described herein can be performed in a cloud computing environment (e.g., comprising virtual machines and underlying infrastructure resources).

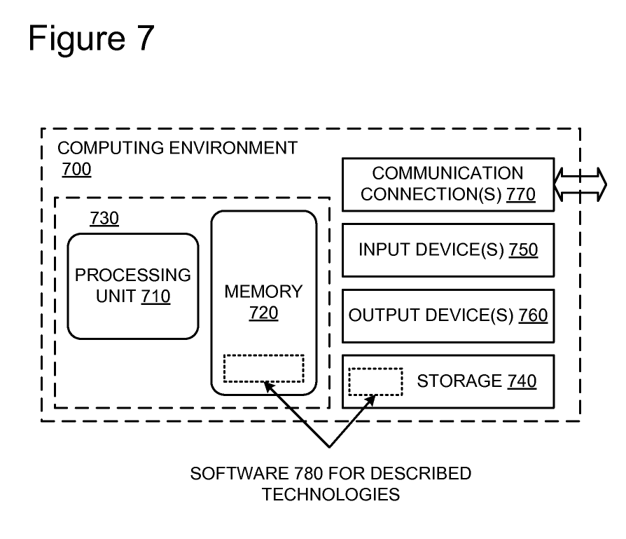

FIG. 7 illustrates a generalized example of a suitable computing environment 700 in which described embodiments, techniques, and technologies may be implemented. The computing environment 700 is not intended to suggest any limitation as to scope of use or functionality of the technology, as the technology may be implemented in diverse general-purpose or special-purpose computing environments. For example, the disclosed technology may be implemented using a computing device (e.g., a server, desktop, laptop, hand-held device, mobile device, PDA, etc.) comprising a processing unit, memory, and storage storing computer-executable instructions implementing the service level management technologies described herein. The disclosed technology may also be implemented with other computer system configurations, including hand held devices, multiprocessor systems, microprocessor-based or programmable consumer electronics, network PCs, minicomputers, mainframe computers, a collection of client/server systems, and the like. The disclosed technology may also be practiced in distributed computing environments where tasks are performed by remote processing devices that are linked through a communications network. In a distributed computing environment, program modules may be located in both local and remote memory storage devices.

With reference to FIG. 7, the computing environment 700 includes at least one central processing unit 710 and memory 720. In FIG. 7, this most basic configuration 730 is included within a dashed line. The central processing unit 710 executes computer-executable instructions. In a multi-processing system, multiple processing units execute computer-executable instructions to increase processing power and as such, multiple processors can be running simultaneously. The memory 720 may be volatile memory (e.g., registers, cache, RAM), non-volatile memory (e.g., ROM, EEPROM, flash memory, etc.), or some combination of the two. The memory 720 stores software 780 that can, for example, implement the technologies described herein. A computing environment may have additional features. For example, the computing environment 700 includes storage 740, one or more input devices 750, one or more output devices 760, and one or more communication connections 770. An interconnection mechanism (not shown) such as a bus, a controller, or a network, interconnects the components of the computing environment 700. Typically, operating system software (not shown) provides an operating environment for other software executing in the computing environment 700, and coordinates activities of the components of the computing environment 700.

The storage 740 may be removable or non-removable, and includes magnetic disks, magnetic tapes or cassettes, CD-ROMs, CD-RWs, DVDs, or any other tangible storage medium which can be used to store information and which can be accessed within the computing environment 700. The storage 740 stores instructions for the software 780, which can implement technologies described herein.

The input device(s) 750 may be a touch input device, such as a keyboard, keypad, mouse, pen, or trackball, a voice input device, a scanning device, or another device, that provides input to the computing environment 700. For audio, the input device(s) 750 may be a sound card or similar device that accepts audio input in analog or digital form, or a CD-ROM reader that provides audio samples to the computing environment 700. The output device(s) 760 may be a display, printer, speaker, CD-writer, or another device that provides output from the computing environment 700.

The communication connection(s) 770 enable communication over a communication medium (e.g., a connecting network) to another computing entity. The communication medium conveys information such as computer-executable instructions, compressed graphics information, or other data in a modulated data signal.

XV. Example Alternatives and Variations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable media (tangible computer-readable storage media, such as one or more optical media discs, volatile memory components (such as DRAM or SRAM), or nonvolatile memory components (such as hard drives)) and executed on a computing device (e.g., any commercially available computer, including smart phones or other mobile devices that include computing hardware). By way of example, computer-readable media include memory 720 and/or storage 740. As should be readily understood, the term computer-readable media does not include communication connections (e.g., 770) such as modulated data signals.

Any of the computer-executable instructions for implementing the disclosed techniques as well as any data created and used during implementation of the disclosed embodiments can be stored on one or more computer-readable media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computing device to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved. We therefore claim as our invention all that comes within the scope and spirit of these claims.

1. A method, implemented at least in part by a computing device, for extracting information from medical documents, the method comprising:
determining a plurality of classes of medical information;
separating the medical documents into past medical information and present medical information;
for each class of the plurality of classes of medical information:
selecting, by the computing device, one or more extraction techniques according to the class; and
using the one or more selected extraction techniques, extracting, by the computing device, information from the medical documents, wherein the medical documents are related to a patient; and
storing, by the computing device, the extracted information;
wherein information is extracted from the past medical information for a past medical history class, and information is extracted from one or more remaining classes using the present medical information.

2. The method of claim 1 further comprising:
determining a type of information consumer, wherein the determining the plurality of classes of medical information is based on the type of information consumer, and wherein the plurality of classes of medical information are relevant to the type of information consumer.

3. The method of claim 1, wherein the plurality of classes of medical information are relevant to a physician.

4. The method of claim 1, wherein the plurality of classes of medical information are relevant to a physician, and wherein the plurality of classes of medical information comprise the following classes:
past medical history;
signs and symptoms;
diagnoses;
treatments;
tests and results; and
follow-ups.

5. The method of claim 1, wherein, for at least two classes of the plurality of classes of medical information, different extraction techniques are selected for each of the at least two classes.

6. The method of claim 1, wherein a plurality of different extraction techniques are used for at least one class of medical information.

7. The method of claim 1, wherein the one or more extraction techniques comprise:
a regular expression based pattern matching technique;
a dictionary based lookup and matching technique; and
a heuristic based passage extraction technique.

8. The method of claim 1, wherein at least one of the one or more extraction techniques utilizes category specific dictionaries associated with the plurality of classes.

9. (canceled)

10. The method of claim 1, wherein the extracted information is stored in a knowledge base, wherein the knowledge base provides contextual searching.

11. A computing device comprising:
a processing unit; and
one or more storage media soring instructions for causing the computing device to perform a method for extracting information from medical documents, the method comprising:
determining a plurality of classes of medical information;
separating the medical documents into past medical information and present medical information;
for each class of the plurality of classes of medical information:
selecting one or more extraction techniques according to the class; and
using the one or more selected extraction techniques, extracting information from the medical documents, wherein the medical documents are related to a patient; and
storing the extracted information;
wherein information is extracted from the past medical information for a past medical history class, and information is extracted from one or more remaining classes using the present medical information.

12. The computing device of claim 11, the method further comprising:
determining a type of information consumer, wherein the determining the plurality of classes of medical information is based on the type of information consumer, and wherein the plurality of classes of medical information are relevant to the type of information consumer.

13. The computing device of claim 11, wherein the plurality of classes of medical information are relevant to a physician, and wherein the plurality of classes of medical information comprise the following classes:
past medical history;
signs and symptoms;
diagnoses;
treatments;
tests and results; and
follow-ups.

14. The computing device of claim 11, wherein, for at least two classes of the plurality of classes of medical information, different extraction techniques are selected for each of the at least two classes, and wherein a plurality of different extraction techniques are used for at least one class of medical information.

15. The computing device of claim 11, wherein the one or more extraction techniques comprise:
a regular expression based pattern matching technique;
a dictionary based lookup and matching technique; and
a heuristic based passage extraction technique.

16. A computer-readable medium storing computer-executable instructions for causing a computing device to perform a method for extracting information from medical documents, the method comprising:
determining a type of information consumer;
determining a plurality of classes of medical information, wherein the determining the plurality of classes of medical information is based on the type of information consumer, and wherein the plurality of classes of medical information are relevant to the type of information consumer;
separating the medical documents into past medical information and present medical information;
for each class of the plurality of classes of medical information:
selecting one or more extraction techniques according to the class; and
using the one or more selected extraction techniques, extracting information from the medical documents, wherein the medical documents are related to a patient; and
storing, by the computing device, the extracted information;
wherein information is extracted from the past medical information for a past medical history class, and information is extracted from one or more remaining classes using the present medical information.

17. The computer-readable medium of claim 16 wherein the type of information consumer is a physician, and wherein the plurality of classes of medical information comprise the following classes:
past medical history;
signs and symptoms;
diagnoses;
treatments;
tests and results; and
follow-ups.

18. The computer-readable medium of claim 16, wherein separating the medical documents into past medical information and present medical information comprises:
for the past medical history class, selecting and using a temporal logic heuristic based extraction technique to segregate the information in the medical documents into past medical information and present medical information;
wherein the temporal logic heuristic based extraction technique uses sets of past and present words to identify sections of the medical documents related to past medical history.

19. The computer-readable medium of claim 16, wherein at least one of the medical documents is an unstructured medical document.

20. The computer-readable medium of claim 16, wherein, for at least two classes of the plurality of classes of medical information, different extraction techniques are selected for each of the at least two classes, and wherein a plurality of different extraction techniques are used for at least one class of medical information.

21. The method of claim 1, wherein the selecting, by the computing device, one or more extraction techniques according to the class comprises:
for a first class of the plurality of classes of medical information, selecting a dictionary based lookup and matching technique as a single technique for extracting information from the medical documents for the first class; and
for a second class of the plurality of classes of medical information, selecting a combination of matching techniques comprising a dictionary based lookup and matching technique and a regular expression based pattern matching technique.

22. The method of claim 21, wherein the first class of medical information is a diagnosis class, and wherein the second class of medical information is a test and test results class.
